(19) United States
(12) Patent Application Publication
(10) Pub. No.: US 2009/0059289 A1
(43) Pub. Date: Mar. 5, 2009

(54) DISPLAY SYSTEM, DISPLAY METHOD, AND STORAGE MEDIUM STORING DISPLAY PROGRAM

(75) Inventors: Hiroshi Shintoku, Kawasaki-shi (JP); Tadanobu Fujita, Yokohama-shi (JP); Yasuo Kurata, Kawasaki-shi (JP); Hiroshi Okubo, Kawasaki-shi (JP); Tetsuhide Takasaki, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/201,470

(22) Filed: Aug. 29, 2008

(30) Foreign Application Priority Data
Aug. 31, 2007 (JP) 2007-226441

(51) Int. Cl. G06F 15/00

(52) U.S. Cl. 358/1.15

(57) ABSTRACT

A display system configured to display a print preview of a roll paper image and a print area includes an acquisition unit configured to acquire a roll paper width, and a horizontal length of a set paper size, a print-area determination unit for determining a print area based on the acquired roll paper width and horizontal length, a determination unit configured to determine whether the determined print area is displayable in a preview area, a calculation unit configured to calculate a scaling required to display the entire print area in a preview according to a vertical length of the print area, and a display control unit configured to, if it is determined by the determination unit that the entire print area is not displayable, preview a roll paper image and a print area based on the scaling calculated by the calculation unit.

### BACKGROUND OF THE INVENTION

1. Field of the Invention

The present invention relates to a display system and a display method, and more particularly to a print preview in roll paper printing.

2. Description of the Related Art

A preview function is important for preventing a printing failure upon printing. In particular, an accurate preview for preventing failures is very effective for a large-format printer. This is because the large-format printer prints data on large paper and, thus, involves a high cost of paper, ink, time, etc., in case of failure.

Most existing printer drivers display a preview for checking the orientation or layout of a print image with symbols or illustrations, without using an actual image. However, a preview using an actual image is discussed in Japanese Patent Application Laid-Open No. 10-40045.

Further, a higher-function preview has been proposed in the field of application. For example, a mechanism is proposed for acquiring information set in a printer and print settings and for displaying a preview based on such information.

Furthermore, a preview that is compatible with roll paper printing has been also proposed. More specifically, a technique of displaying a roll paper width based on information acquired from a printer driver and, in addition, accurately previewing an image with an accurate print page size, layout, or the like based on acquired print settings is discussed in Japanese Patent Application Laid-Open No. 2006-202112.

According to conventional techniques, in the case of displaying a roll paper preview as a print preview of a vertically-long original, even the first page may not entirely be displayed depending on the resolution of a screen or the like, thus resulting in a problem that the entire image of the page cannot be checked with ease.

Furthermore, even on an initial screen that is displayed at start-up of roll paper preview, the above-mentioned phenomenon may occur. Thus, visibility is low, and current settings cannot be grasped with ease, leading to a problem that an image cannot be checked and printed speedily.

Moreover, the following problems may occur. If a user intends to confirm a print preview of plural pages, a print preview of only a part of the pages may be displayed depending on the relationship between a roll paper width and paper size, so that a user cannot check a layout with ease. Accordingly, the user may find failures accompanying errors in a print layout or settings only after the completion of actual printing, and may waste paper, ink, and time.

In addition, there is a problem that a user is required to change various settings, such as display magnification, so as to check the above failures, thus consuming a lot of time.

### SUMMARY OF THE INVENTION

The present invention is directed to a display system capable of automatically displaying an entire print area in one screen and allowing a user to easily find any errors in a print image or layout setting. In addition, the present invention is directed to a display system capable of reducing printing failures accompanying errors in a print layout or setting, saving paper and ink, and improving printing efficiency.

According to an aspect of the present invention, a display system configured to display a print preview of a roll paper image and a print area includes an acquisition unit configured to acquire a roll paper width, and a horizontal length of a set paper size, a print-area determination unit for determining a print area based on the acquired roll paper width and horizontal length, a determination unit configured to determine whether the determined print area is displayable in a preview area, a calculation unit configured to calculate a scaling required to display the entire print area in a preview according to a vertical length of the print area, and a display control unit configured to, if it is determined by the determination unit that the entire print area is not displayable, preview a roll paper image and a print area based on the scaling calculated by the calculation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a display system according to a first exemplary embodiment of the present invention.

FIG. 2 illustrates a general driver user interface unit used in a user interface unit illustrated in FIG. 1.

FIG. 3 illustrates a roll paper preview in a general printer driver controlled by a print preview control unit illustrated in FIG. 1.

FIG. 4 is an explanatory view illustrating a method for determining a print area.

FIG. 5 illustrates an example of a roll paper preview according to the first exemplary embodiment.

FIG. 6 illustrates a typical example of a roll paper preview according to the first exemplary embodiment.

FIG. 7 is an explanatory view illustrating a method for calculating a display magnification applied to the roll paper preview illustrated in FIG. 6.

FIG. 8 is a flowchart illustrating a main operation of the display system for displaying a roll paper preview according to the first exemplary embodiment.

FIG. 9 is a flowchart illustrating an example of a method for calculating a print area according to the first exemplary embodiment.

FIG. 10 illustrates a display system according to a second exemplary embodiment of the present invention.

FIG. 11 illustrates an example of a roll paper preview according to the second exemplary embodiment.

FIG. 12 is an explanatory view illustrating a method for calculating a print area according to the second exemplary embodiment.

FIG. 13 is an explanatory view illustrating a method for calculating a display magnification applied to the roll paper preview illustrated in FIG. 11.

### DETAILED DESCRIPTION OF THE EMBODIMENTS

Various exemplary embodiments, features, and aspects of the invention will be described in detail below with reference to the drawings.

### First Exemplary Embodiment

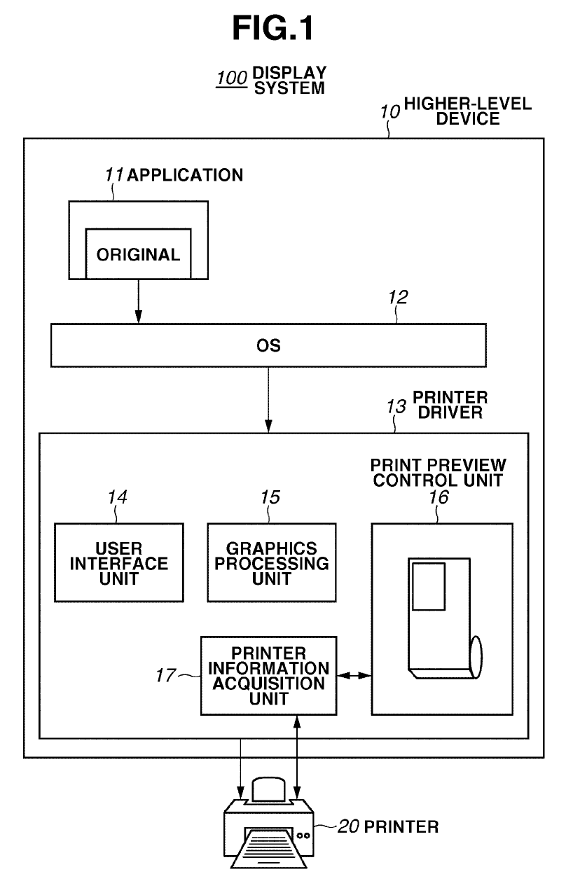

FIG. 1 illustrates a display system 100 according to a first exemplary embodiment of the present invention. The display system 100 includes a higher-level device 10, such as a personal computer, and a printer 20. The higher-level device 10 includes an application 11, an operating system (OS) 12, and a printer driver 13.

The printer driver 13 includes a user interface unit 14, a graphics processing unit 15, a print preview control unit 16, and a printer information acquisition unit 17. The user interface unit 14 receives input data from a user. The print preview control unit 16 controls a print preview. The printer information acquisition unit 17 acquires printer information, such as the width of set roll paper, from the printer 20. The printer 20 is a large-format inkjet image forming apparatus.

A general printing operation of the display system 100 is described next. In the higher-level device 10, the application 11 generates various types of documents. The OS 12 and the printer driver 13 operate to print the documents with the printer 20.

The application 11 acquires paper information, such as the number of pixels corresponding to a designed paper size, using a function provided by the OS 12 as print preprocessing. In response to a request for the function, the OS 12 calls a print function for initial setting that is provided by the printer driver 13 to acquire paper information and sends the acquired paper information to the application 11.

Then, the application 11 reconstructs a document based on the acquired paper information and executes print processing using the print function provided by the OS 12. If the print function is called, the OS 12 calls print functions, such as a print control function (print start, print end, etc.) and a text, graphic, and image drawing function, provided by the printer driver 13.

After such functions are called, the printer driver 13 generates print data in a format recognizable by the printer 20, and the print preview control unit 16 displays a print preview and sends the print data to the printer 20. The printer information acquisition unit 17 serves as a communication module, which is called by the printer driver 13 for acquiring various types of information from the printer 20.

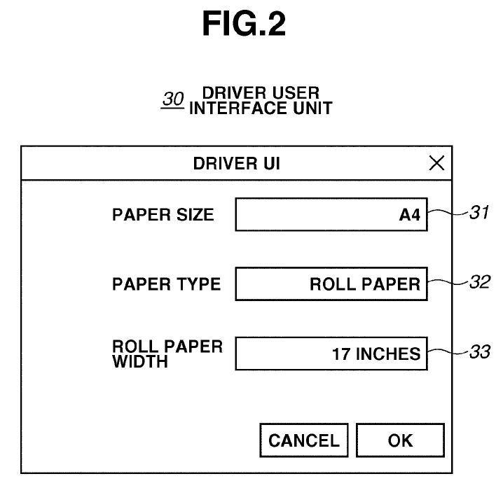

FIG. 2 illustrates a general driver user interface unit 30 that is included in the user interface unit 14 illustrated in FIG. 1. A control field 31 is used to set a paper size on the driver side. A control field 32 is used to set a paper type. A control field 33 is used to set a roll paper width.

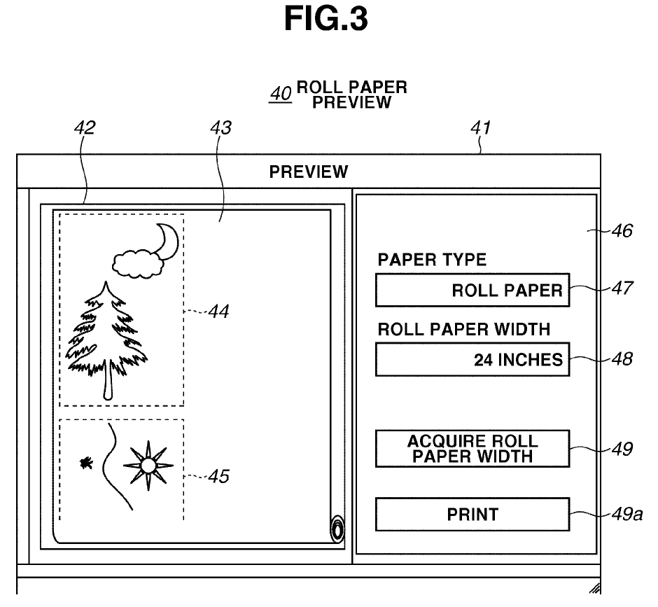

FIG. 3 illustrates a roll paper preview 40 on a general printer driver controlled by the print preview control unit 16 illustrated in FIG. 1. The displayed roll paper preview 40 includes a roll paper preview dialog 41, a preview display area 42, a roll paper image 43, a print area 44 of the first page, a print area 45 of the second page, and a display field 46 for driver setting.

Further, the displayed roll paper preview 40 includes a paper type field 47, a roll paper width field 48, a button 49, and a print button 49a. The roll paper preview dialog 41 is opened by the driver. The roll paper image 43 is displayed within the preview display area 42. The print area 44 of the first page is displayed on the roll paper image 43. The button 49 is used to acquire a roll paper width. If a user presses the button 49 at any timing, the printer information acquisition unit 17 acquires a roll paper width, which is the width of roll paper set in the printer 20.

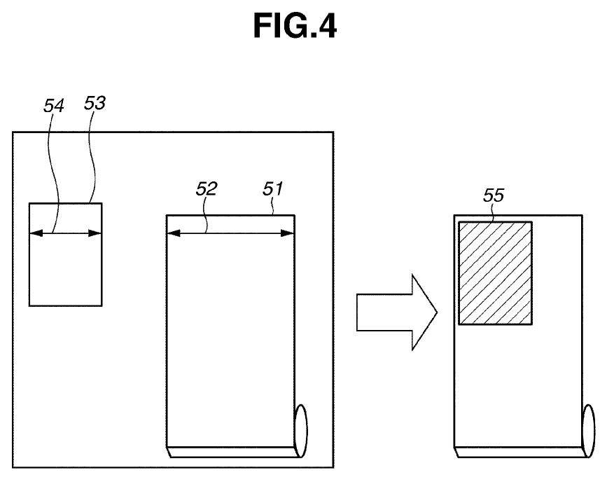

FIG. 4 is an explanatory view illustrating a method for determining a print area 55. The print area 55 is defined by locating the paper size 53, set in the printer driver, with a fixed aspect ratio on the roll paper 51.

The print area 55 can be determined based on a ratio between a roll paper width 52 and a horizontal length 54 of the paper size 53. The term “locating the paper size 53 with fixed aspect ratio” means to change the vertical length and the horizontal length of paper size at equal magnification to scale up/down a print image.

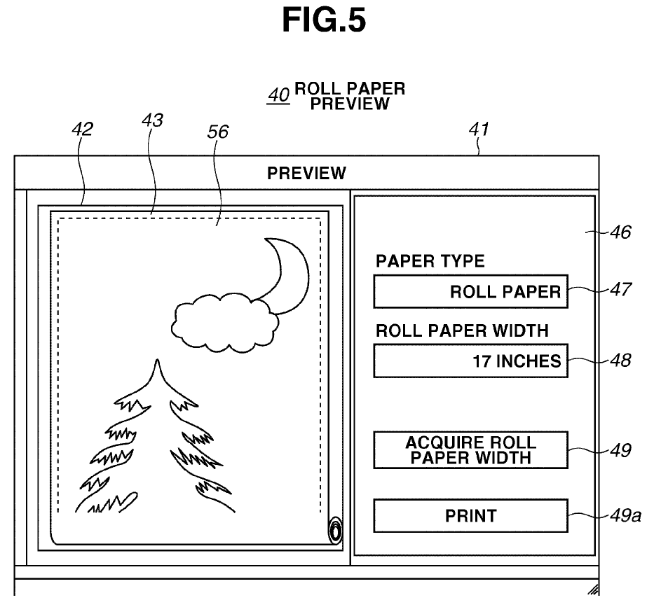

FIG. 5 illustrates an example of a roll paper preview according to the first exemplary embodiment. A print area 56 illustrated in FIG. 5 differs from the print area 44 illustrated in FIG. 3 in that not the entire print area is displayed in the preview display area 42 because the ratio of the print area 55 to the roll paper width 52 in FIG. 4 has increased. In this pattern, a print area is large relative to roll paper in the case where a roll paper width is small, for example.

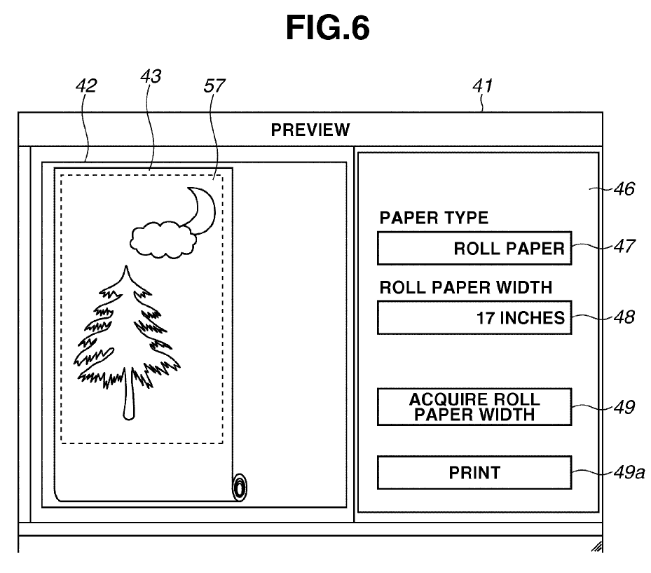

FIG. 6 illustrates a typical example of a roll paper preview according to the first exemplary embodiment. In FIG. 6, the selected roll paper width 48 is the same as that illustrated in FIG. 5. However, since the roll paper image 43 and the print area 57 are displayed in reduced size, the entire print area 57 is displayed within the preview display area 42.

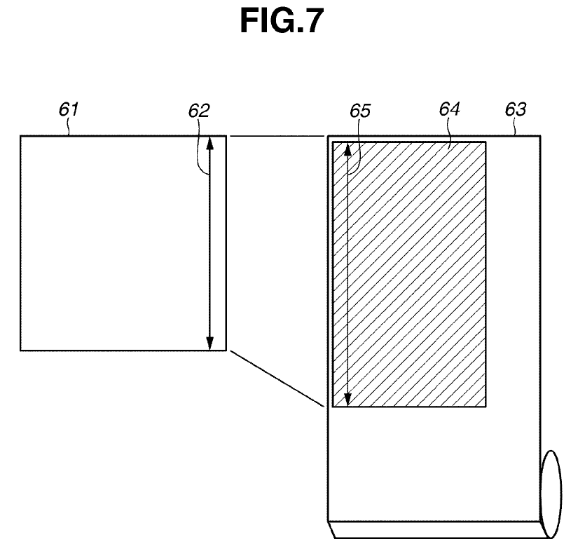

FIG. 7 is an explanatory view illustrating a method for calculating a display magnification applied to the roll paper preview illustrated in FIG. 6. Suppose that A represents the display magnification. The display magnification A satisfies a condition of “(vertical length 62 of a preview area 61)>(vertical length 65 of a print area 64)*A”. The display magnification A is applied to a roll paper image 63 and the print area 64 to display the roll paper image 63 and the print area 64 as the roll paper image 43 and the print area 57 in FIG. 6. Thus, the roll paper preview illustrated in FIG. 6 can be obtained.

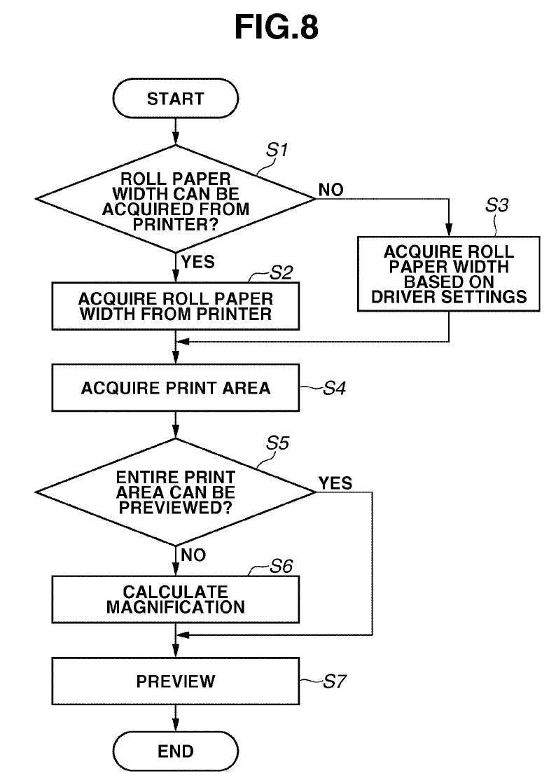

Next, detailed operations of the first exemplary embodiment are described. FIG. 8 is a flowchart illustrating a main operation of the display system 100 for displaying a roll paper preview. How the printer driver 13 displays a roll paper preview upon printing a document including plural pages in the display system 100 illustrated in FIG. 1 is described.

This operation is applicable to any other systems having a roll paper preview function as well as the printer driver 13. In the first exemplary embodiment, this operation is executed at start-up of a roll paper preview.

When a roll paper preview function is performed, in step S1, the printer driver 13 determines whether a roll paper width can be acquired from the printer 20. If a roll paper width can be acquired from the printer 20 (YES in step S1), then in step S2, the printer driver 13 acquires a roll paper width with the printer information acquisition unit 17. If a roll paper width cannot be acquired from the printer 20 (NO in step S1), then in step S3, the printer driver 13 uses a roll paper width preset with the driver user interface unit 30 illustrated in FIG. 2. Next, in step S4, the printer driver 13 acquires the print area 44 of the first page.

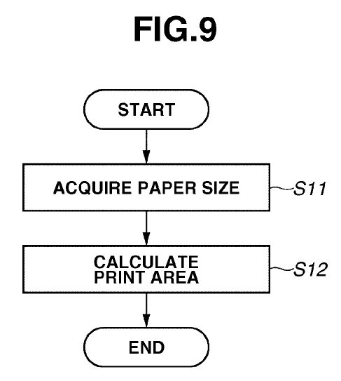

FIG. 9 is a flowchart illustrating an example of a method for calculating a print area. The printer driver 13 acquires a selected paper size in step S11, and calculates a print area in step S12. The processing in step S12 is illustrated in detail in FIG. 4. The acquired paper size corresponds to the paper size 53. The printer driver 13 determines the print area 55 based on the acquired roll paper width 52, paper size 53, and horizontal length 54 of the paper size 53, as illustrated in FIG. 4.

Consider the case of maximizing the roll paper width in the display area 42 at start-up of a roll paper preview. In this case, the determined print area of the first page may entirely be displayed in the preview display area 42 like the print area 44 of the first page illustrated in FIG. 3.

A lower portion of the print area 56 may not be displayed as illustrated in FIG. 5 depending on the acquired roll paper width and paper size. In step S5, the printer driver 13 determines whether the entire print area of the first page can be displayed as described above. If the entire area can be displayed (YES in step S5), then in step S7, the printer driver 13 displays a roll paper preview as illustrated in FIG. 3.

If not the entire print area can be displayed (NO in step S5), then in step S6, the printer driver 13 determines a display magnification required to display the entire print area. FIG. 7 illustrates an example of a method of calculating the display magnification.

As described above, the printer driver 13 compares the vertical length 65 of the print area 64 with the vertical length 62 of the preview area 61 to calculate a display magnification. When the calculated display magnification is applied to the roll paper image 63 and the print area 64, the roll paper image 43 and the print area 57 are displayed as illustrated in FIG. 6.

In other words, the entire print area 56, a part of which is not displayed in the case illustrated in FIG. 5, is displayed as the print area 57 as illustrated in FIG. 6. As a result, a print layout is recognizable at a glance. The display system 100 is a driver of a personal computer (PC) for illustrative purposes, but can be a system for generating a preview with a printing apparatus body and displaying the preview on the screen of a PC with a browser.

### Second Exemplary Embodiment

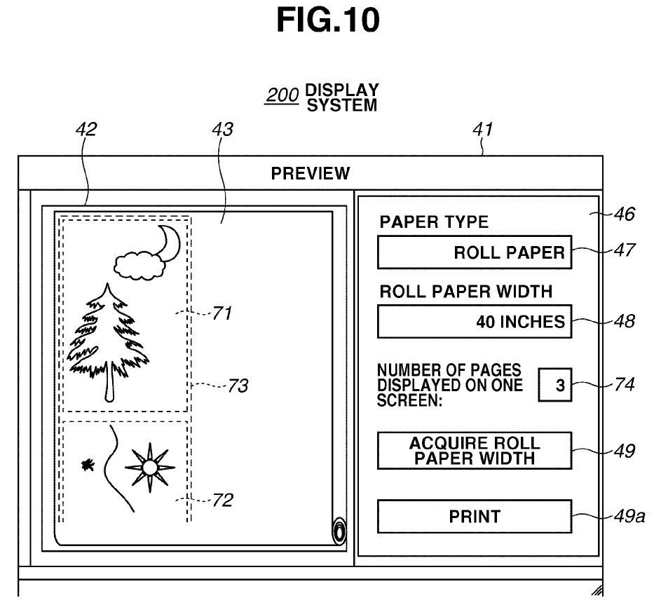

FIG. 10 illustrates a display system 200 according to a second exemplary embodiment of the present invention. In the second exemplary embodiment, plural pages are selected as a preview print area. The components and operations of the first exemplary embodiment as illustrated in FIGS. 1 to 7 are similar to those of the second exemplary embodiment.

In the display system 200 illustrated in FIG. 10, a print preview 71 of the first page of an original to be printed, a print preview 72 of the second page, and a print preview 73 of plural pages are displayed. In a field 74 for designating the number of display pages, the number of pages displayed on one screen at a time is set. Plural pages can be selected based on a method other than the method described in the second exemplary embodiment. In this example, the number of pages is set to 3.

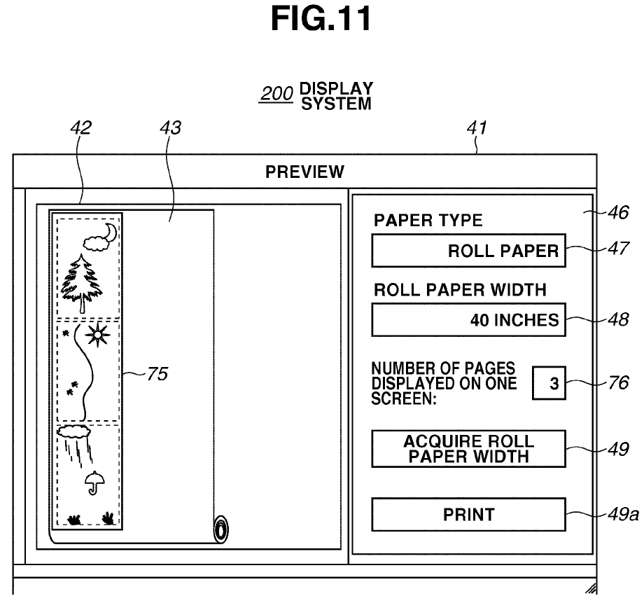

FIG. 11 illustrates an example of a roll paper preview according to the second exemplary embodiment. The entire print area 75 is displayed on the roll paper image 43 displayed in the preview display area 42. In the example illustrated in FIG. 11, images corresponding to three pages are displayed.

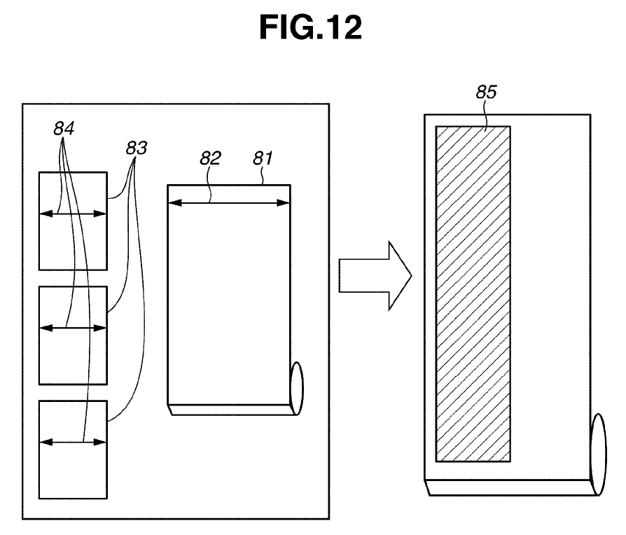

FIG. 12 is an explanatory view illustrating a method for calculating a print area according to the second exemplary embodiment. In the second exemplary embodiment, plural pages are selected as a target print area. Here, three pages are selected as a print area 85. The print area 85 is defined by locating three pages of paper size 83 with fixed aspect ratio on a roll paper 81. The print area 85 can be calculated based on a ratio between a roll paper width 82 and the horizontal length 84 of the paper size 83.

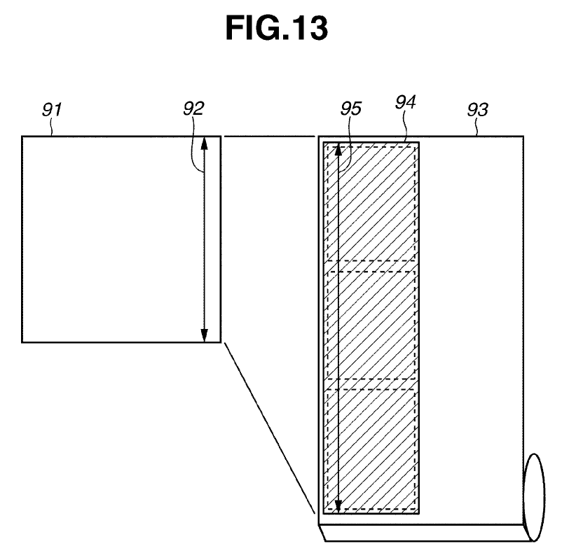

FIG. 13 is an explanatory view illustrating a method for calculating a display magnification applied to the roll paper preview illustrated in FIG. 11. Suppose that B represents the display magnification. The display magnification B satisfies a condition of “(vertical length 92 of a preview area 91)>(vertical length 95 of a print area 94)*B”.

When the display magnification B is applied to a roll paper image 93 and the print area 94, the roll paper image 93 and the print area 94 are displayed as the roll paper image 43 and the print area 75 in FIG. 11. Thus, the roll paper preview illustrated in FIG. 11 can be obtained.

Referring to the flowchart illustrated in FIG. 8, the second exemplary embodiment is described in detail below. In the second exemplary embodiment, the printer driver 13 previews a roll paper image upon printing a document including plural pages in the display system 200. However, this operation is applicable to all systems having a roll paper preview function as well as the printer driver 13.

If a roll paper preview is executed, first, in step S1, the printer driver 13 determines whether a roll paper width can be acquired from the printer 20. If a roll paper width can be acquired from the printer 20 (YES in step S1), then in step S2, the printer driver 13 acquires a roll paper width with the printer information acquisition unit 17.

If a roll paper width cannot be acquired from the printer main body (NO in step S1), then in step S3, the printer driver 13 uses a roll paper width preset by the driver user interface unit 30 illustrated in FIG. 2.

In the second exemplary embodiment, the number of pages to be previewed at a time is set in the field 74 illustrated in FIG. 10 for designating the number of display pages. In this example, the number of pages is set to 3. Next, in step S4, the printer driver 13 acquires a print area corresponding to the selected pages.

Further, in step S11 illustrated in FIG. 9, the printer driver 13 acquires a selected paper size, and calculates a print area in step S12. The processing in step S12 is illustrated in detail in FIG. 12. The printer driver 13 determines the print area 85 based on the acquired roll paper width 82, paper size 83, and horizontal length 84 of the paper size 83 as illustrated in FIG. 12.

Here, consider the case of maximizing a roll paper width in the preview display area 42 at start-up of a roll paper preview. In this case, the calculated print area 85 including plural pages may not entirely be displayed, like the print preview 72 of the second page of the original illustrated in FIG. 10, depending on the acquired roll paper width and paper size. In step S5, the printer driver 13 determines whether the entire print area can be displayed.

If the entire print area can be displayed (YES in step S5), then in step S7, the printer driver 13 displays a roll paper preview. If not the entire print area can be displayed (NO in step S5), then in step S6, the printer driver 13 determines a display magnification required to display the entire print area.

FIG. 13 illustrates an example of a method of determining the display magnification. The printer driver 13 compares the vertical length 95 of the print area 94 with the vertical length 92 of the preview area 91 to determine a display magnification. When the determined display magnification is applied to the roll paper image 93 and the print area 94, the roll paper image 43 and the print area 75 illustrated in FIG. 11 are displayed.

As a result, as illustrated in FIG. 11, the entire print area 75 including plural pages is displayed. Thus, a print layout is recognizable at a glance.

According to the first and second exemplary embodiments, the preview magnification (scaling) of a roll paper image and a print area is controlled based on a roll paper width and a paper size. Accordingly, the entire print area can be automatically displayed on one screen, and a user can easily find any errors in a print image or layout setting.

Furthermore, since the entire area of the first page of an original can be displayed at start-up of print preview, or plural pages selected by a user can be displayed on one screen, visibility is dramatically improved. In other words, a user can speedily confirm whether a printing result satisfies a user's requirement.

Moreover, the above-described high-visibility print preview can reduce a print error that would occur due to any error in a print layout or settings, save paper and ink, and enhance printing efficiency. While the above-described exemplary embodiments are applied to a preview function performed by a printer driver, they are applicable to a preview function performed by an application program.

Additionally, the above-described exemplary embodiments are applicable to the case where a printer body is provided with a display device to display a preview. Furthermore, the above-described exemplary embodiments are applicable to a print system including a PC and a printer body, which generates a preview with the printer body and displays the preview on the PC.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-226441 filed Aug. 31, 2007, which is hereby incorporated by reference herein in its entirety.

What is claimed is:

1. A display system configured to display a print preview of a roll paper image and a print area, the display system comprising:
an acquisition unit configured to acquire a roll paper width, and a horizontal length of a set paper size;
a print-area determination unit for determining a print area based on the acquired roll paper width and horizontal length;
a determination unit configured to determine whether the determined print area is displayable in a preview area;
a calculation unit configured to calculate a scaling required to display the entire print area in a preview according to a vertical length of the print area; and
a display control unit configured to, if it is determined by the determination unit that the entire print area is not displayable, preview a roll paper image and a print area based on the scaling calculated by the calculation unit.

2. The display system according to claim 1, wherein the acquisition unit is configured to acquire a paper size of an original to be printed, and
wherein the print-area determination unit is configured to determine the print area based on the acquired roll paper width and the acquired paper size.

3. The display system according to claim 1, wherein the print-area determination unit is configured so that, if a print preview of a single page is to be displayed, the print-area determination unit is configured to set a first page as the print area.

4. The display system according to claim 1, wherein the print-area determination unit is configured so that, if a print preview of a plurality of pages is to be displayed, the print-area determination unit is configured to set the plurality of pages as the print area.

5. The display system according to claim 4, wherein the print-area determination unit is configured to set a print area corresponding to a number of pages selected by a user as the print area.

6. The display system according to claim 1, wherein the acquisition unit is configured to acquire a roll paper width from a printing apparatus or to acquire a set value of a printer driver as a roll paper width.

7. The display system according to claim 6, wherein if a roll paper width cannot be acquired from the printing apparatus, the acquisition unit is configured to acquire a roll paper width based on a set value of the printer driver.

8. The display system according to claim 1, wherein if a print preview of a plurality of pages is to be displayed, the acquisition unit is configured to acquire a horizontal length of a first page for setting the print area at start-up of the print preview.

9. A display method for displaying a print preview of a roll paper image and a print area, the display method comprising:
acquiring a roll paper width and a horizontal length of a set paper size;
determining a print area based on the acquired roll paper width and horizontal length;
determining whether the determined print area is displayable in a preview area;
calculating a scaling required to display the entire print area in a preview according to a vertical length of the print area; and
if it is determined that the entire print area is not displayable, previewing a roll paper image and a print area based on the calculated scaling.

10. The display method according to claim 9, further comprising:
acquiring a paper size of an original to be printed; and
determining the print area based on the acquired roll paper width and the acquired paper size.

11. The display method according to claim 9, further comprising, if a print preview of a single page is to be displayed, setting the first page as the print area.

12. The display method according to claim 9, further comprising, if a print preview of a plurality of pages is to be displayed, setting the plurality of pages as the print area.

13. The display method according to claim 12, further comprising setting a print area corresponding to a number of pages selected by a user as the print area.

14. The display method according to claim 9, further comprising acquiring a roll paper width from a printing apparatus or acquiring a set value of a printer driver as a roll paper width.

15. The display method according to claim 14, further comprising, if a roll paper width cannot be acquired from the printing apparatus, acquiring a roll paper width based on a set value of the printer driver.

16. The display method according to claim 9, further comprising, if a print preview of a plurality of pages is to be displayed, acquiring a horizontal length of a first page for setting the print area at start-up of the print preview.

17. A storage medium storing a program for causing a computer to perform a method comprising:
acquiring a roll paper width and a horizontal length of a set paper size;
determining a print area based on the acquired roll paper width and horizontal length;
determining whether the determined print area is displayable in a preview area;
calculating a scaling required to display the entire print area in a preview according to a vertical length of the print area; and
if it is determined that the entire print area is not displayable, previewing a roll paper image and a print area based on the calculated scaling.

18. A display system configured to display a print preview of a roll paper image and a print area, the display system comprising:
means for acquiring a roll paper width and a horizontal length of a set paper size;
means for determining a print area based on the acquired roll paper width and horizontal length;
means for determining whether the determined print area is displayable in a preview area;
means for calculating a scaling required to display the entire print area in a preview according to a vertical length of the print area; and
means for previewing, if it is determined by the determination means that the entire print area is not displayable, a roll paper image and a print area based on the scaling calculated by the calculation means.
